(19) United States
(12) Patent Application Publication
(10) Pub. No.: US 2025/0321914 A1
(43) Pub. Date: Oct. 16, 2025

(54) UNIVERSAL SERIAL BUS DEVICE AND CONTROL METHOD THEREOF

(71) Applicant: REALTEK SEMICONDUCTOR CORPORATION, Hsinchu (TW)

(72) Inventor: YING-JEN YEN, Hsinchu (TW)

(21) Appl. No.: 19/173,141

(22) Filed: Apr. 8, 2025

(30) Foreign Application Priority Data
Apr. 12, 2024 (TW) 113113885

(51) Int. Cl. G06F 13/38

(52) U.S. Cl. CPC G06F 13/382; G06F 2212/1028; G06F 2213/0042

(57) ABSTRACT

A universal serial bus device includes a resistor, a decision circuit, and a control circuit. The resistor is configured to receive a power supply voltage selectively. The decision circuit is configured to determine whether to remove the resistor based on at least one state of the universal serial bus device. If the decision circuit determines to remove the resistor based on the at least one state of the universal serial bus device, the decision circuit generates a removing signal. The control circuit is configured to remove the resistor based on the removing signal.

### BACKGROUND OF THE INVENTION

### 1. Field of the Invention

The present disclosure relates to a universal serial bus device and a control method thereof, especially to a universal serial bus device and a control method thereof that remove a resistor based on a state of the universal serial bus device.

### 2. Description of Related Art

To extend the usage time of electronic products, many electronic devices are equipped with a low-power mode. In the low-power mode, the power consumed by the pull-up resistor of the universal serial bus (USB) interface accounts for a great proportion of the overall circuit power, which fails to meet power-saving requirements of electronic products.

### SUMMARY OF THE INVENTION

In some aspects, an object of the present disclosure is to, but not limited to, provides a universal serial bus device and a control method thereof that makes an improvement to the prior art.

An embodiment of the universal serial bus device of the present disclosure includes a resistor, a decision circuit, and a control circuit. The resistor is configured to selectively receive a power supply voltage. The decision circuit is configured to determine whether to remove the resistor based on at least one state of the universal serial bus device. If the decision circuit determines to remove the resistor based on the at least one state of the universal serial bus device, the decision circuit generates a removing signal. The control circuit is configured to remove the resistor based on the removing signal.

An embodiment of the control method of the universal serial bus device of the present disclosure includes: selectively receiving a power supply voltage by a resistor; determining whether to remove the resistor based on at least one state of the universal serial bus device by a decision circuit; if the decision circuit determines to remove the resistor based on the at least one state of the universal serial bus device, the decision circuit generates a remove signal; and removing the resistor based on the remove signal by a control circuit.

Technical features of some embodiments of the present disclosure make an improvement to the prior art. The universal serial bus device and the control method thereof can adaptively remove a resistor based on the state of the universal serial bus device, thereby avoiding additional power consumption caused by the resistor to meet the power-saving requirements of electronic products.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a universal serial bus device and an electronic equipment of the present disclosure.

FIG. 2 shows an embodiment of a flow diagram of a control method of a universal serial bus device of the present disclosure.

FIG. 3 shows an embodiment of an operation diagram of a universal serial bus device of the present disclosure.

FIG. 4 shows an embodiment of an operation diagram of a universal serial bus device of the present disclosure.

FIG. 5 shows an embodiment of an operation diagram of a universal serial bus device of the present disclosure.

FIG. 6 shows an embodiment of an operation diagram of a universal serial bus device of the present disclosure.

FIG. 7 shows an embodiment of a universal serial bus device and an electronic equipment of the present disclosure.

### DETAILED DESCRIPTION OF THE PREFERRED EMBODIMENTS

To address the problem of higher power consumption caused by a pull-up resistor in the prior art, which fails to meet power-saving requirements of electronic products, the present disclosure provides a universal serial bus device and a control method thereof, which will be explained in detail as shown below.

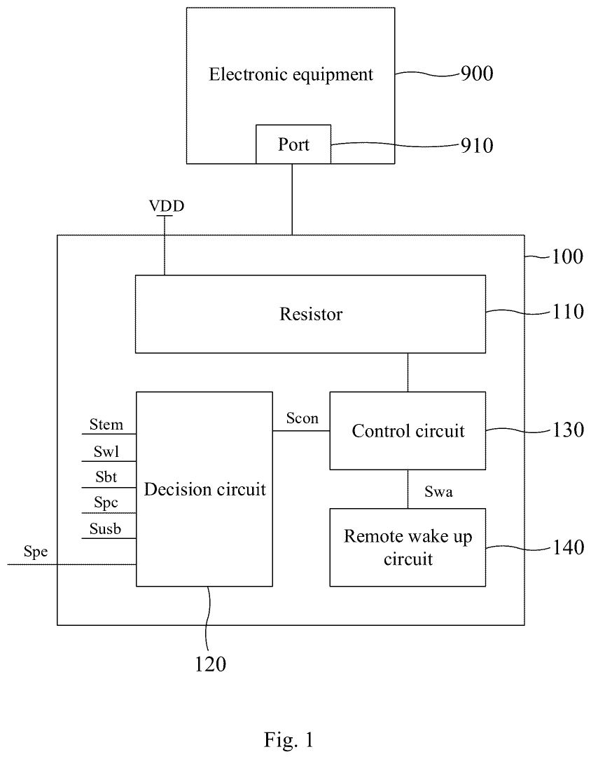

FIG. 1 shows an embodiment of a universal serial bus (USB) device 100 and an electronic equipment 900 of the present disclosure. As shown in the figure, the universal serial bus device 100 includes a resistor 110, a decision circuit 120, and a control circuit 130. In some embodiments, the universal serial bus device 100 is coupled to the port 910 of the electronic equipment 900. For example, the universal serial bus device 100 can be a USB device, such as a Wi-Fi device, a Bluetooth device, a mass storage device, and so on. The electronic equipment 900 can be a computer. The port 910 can be a USB port. However, the above-mentioned embodiment is merely utilized to describe one of the implementations, and the present disclosure is not limited thereto. In another embodiment, the universal serial bus device 100, the electronic equipment 900, and the port 910 of the present disclosure can be implemented by other electronic devices/elements based on actual requirements.

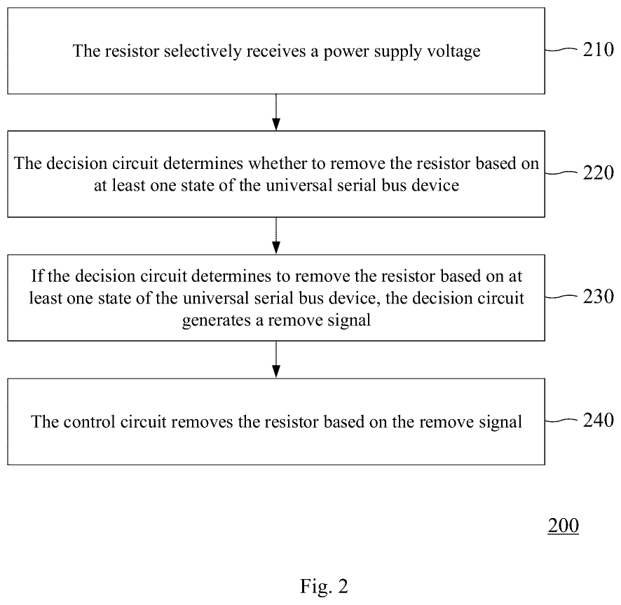

For facilitating the understanding of operations of the universal serial bus device 100, reference is made to FIG. 2. FIG. 2 shows an embodiment of a flow diagram of a control method 200 of a universal serial bus device 100 of the present disclosure.

In step 210, the resistor 110 selectively receives a power supply voltage VDD. In some embodiments, if the resistor 110 of the universal serial bus device 100 is utilized as a pull-up resistor, the power consumption of the pull-up resistor is high, which fails to meet power-saving requirements of electronic products. Therefore, in the subsequent step 220, the decision circuit 120 determines whether to remove the resistor 110 based on at least one state of the universal serial bus device 100. For example, the decision circuit 120 can determine whether to remove the resistor 110 based on a system state Stem, a WLAN state Swl, a Bluetooth state Sbt, a PCIe state Spc and/or a universal serial bus state Susb of the universal serial bus device 100. In some embodiments, the decision circuit 120 can determine whether to remove resistor 110 based on a state of a host control interface (HCl) or other internal state/signal of the universal serial bus device 100.

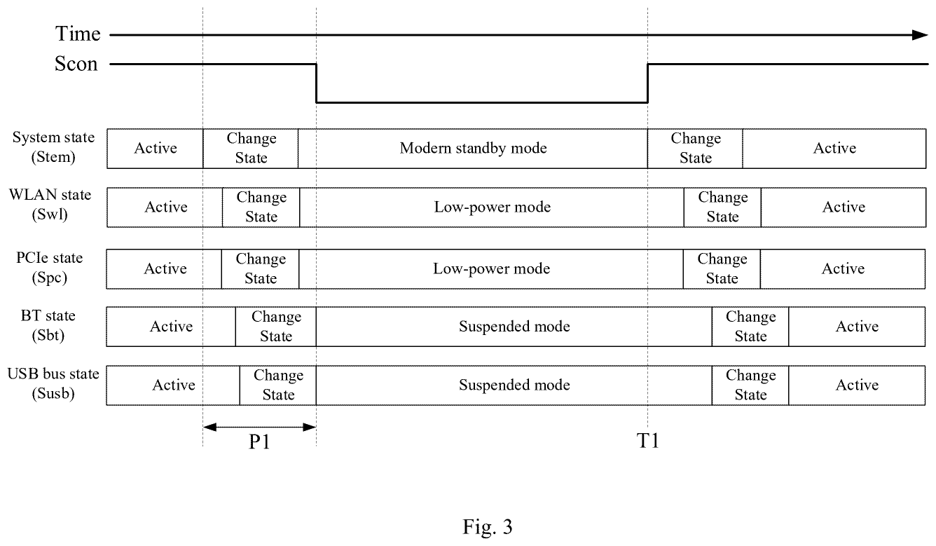

FIG. 3 shows an embodiment of an operation diagram of a universal serial bus device 100 of the present disclosure. As shown in the figure, the decision circuit 120 can detect the system state Stem, the WLAN state Swl, the PCIe state Spc, the Bluetooth state Sbt, and/or the universal serial bus state Susb during the period P1 for determining whether to remove the resistor 110.

In step 230, if the decision circuit 120 determines to remove the resistor 110 based on at least one state of the universal serial bus device 100, the decision circuit 120 generates a remove signal Scon. For example, referring to FIG. 3, if the system state Stem, the WLAN state Swl, the PCIe state Spc, the Bluetooth state Sbt, and the universal serial bus state Susb of the universal serial bus device 100 are all in off state, the decision circuit 120 determines to remove the resistor 110, and the decision circuit 120 generates the remove signal Scon (e.g., low electrical level signal). In the subsequent step 240, the control circuit 130 removes the resistor 110 based on the remove signal Scon (e.g., low electrical level signal).

Referring to FIG. 3, if the decision circuit 120 detects the system state Stem, the WLAN state Swl, the PCIe state Spc, the Bluetooth state Sbt, and the universal serial bus state Susb are all changed states into off state during the period P1, it represents that the universal serial bus device 100 enters the low-power mode (e.g., modern standby mode, low-power mode, suspended mode). As this time, the decision circuit 120 determines to remove the resistor 110, and the decision circuit 120 generates the remove signal Scon (e.g., low electrical level signal). Subsequently, the control circuit 130 removes the resistor 110 based on the remove signal Scon (e.g., low electrical level signal).

In view of the above, the universal serial bus device 100 and the control method 200 thereof of the present disclosure can adaptively remove the resistor 110 based on the state of the universal serial bus device 100, thereby avoiding additional power consumption caused by the resistor 110 to meet the power-saving requirements of electronic products.

In some embodiments, after the control circuit 130 receives the remove signal Scon (e.g., low electrical level signal), the control circuit 130 can remove the resistor 110 by unloading (or not mounting) the resistor 110 or cut off power to the resistor 110 to avoid additional power consumption caused by the resistor 110.

In some embodiments, the decision circuit 120 determines whether to connect the resistor based on the at least one state of the universal serial bus device 100. Reference is made to FIG. 3. First of all, the operations of the decision circuit 120 detecting the state during the period P1 and the control circuit 130 removing the resistor 110 are described in the above-mentioned embodiment, and the operations are therefore omitted herein. Besides, if the system state Stem, the WLAN state Swl, the PCIe state Spc, the Bluetooth state Sbt, or the universal serial bus state Susb of the universal serial bus device 100 is in a change state, it represents that the universal serial bus device 100 is about to execute a transmission operation. The decision circuit 120 determine to connect the resistor 110 in a wake up time T1, the decision circuit 120 generates a connection signal Scon (e.g., high electrical level signal), and the control circuit 130 connect the resistor 110 based on the connection signal Scon (e.g., high electrical level signal).

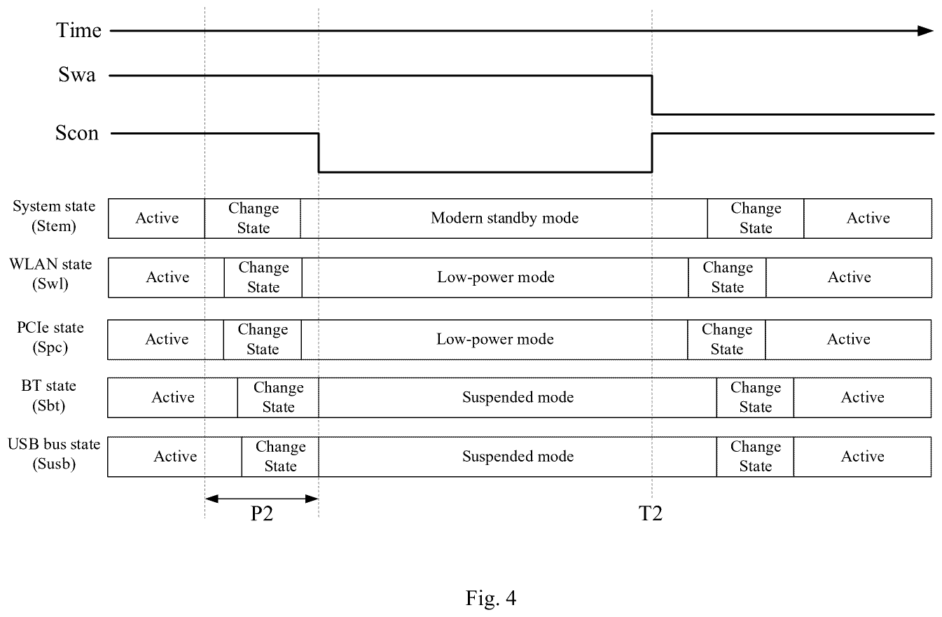

In some embodiments, referring to FIG. 1, the universal serial bus device 100 further includes a remote wake up (e.g., Wake-on-LAN, WoL) circuit 140. Reference is made to both FIG. 1 and FIG. 4. First of all, the operations of the decision circuit 120 detecting the state during the period P2 and the control circuit 130 removing the resistor 110 are described in the above-mentioned embodiment in FIG. 3, and the operations are therefore omitted herein. Besides, the Remote wake up circuit 140 can transmit a wake up signal Swa (e.g., low electrical level signal) to the control circuit 130 during the time T2, and the control circuit 130 connects the resistor 110 based on the wake up signal Swa (e.g., low electrical level signal). In some embodiments, the wake up signal Swa can be a WLAN wake up signal or a Bluetooth wake up signal.

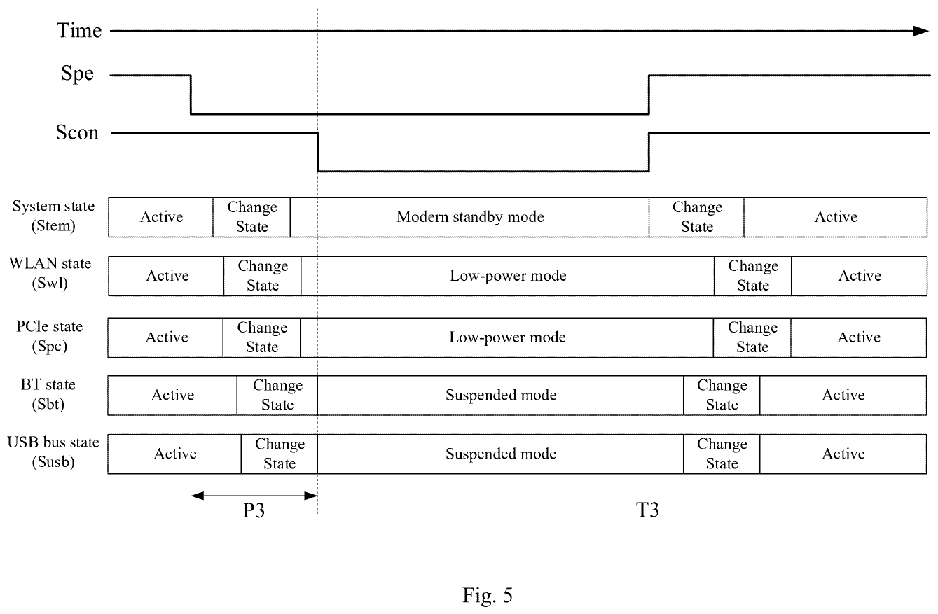

In some embodiments, reference is made to both FIG. 1 and FIG. 5. First of all, the operations of the decision circuit 120 detecting the state during the period P3 and the control circuit 130 removing the resistor 110 are described in the above-mentioned embodiment in FIG. 3, and the operations are therefore omitted herein. Besides, the decision circuit 120 of the present disclosure can generate the connection signal Scon (e.g., high electrical level signal) based on the PCIe reset (PERST) state Spe (e.g., high electrical level signal) of the external device during the time T3, and the control circuit 130 connects the resistor 110 based on the connection signal Scon (e.g., high electrical level signal).

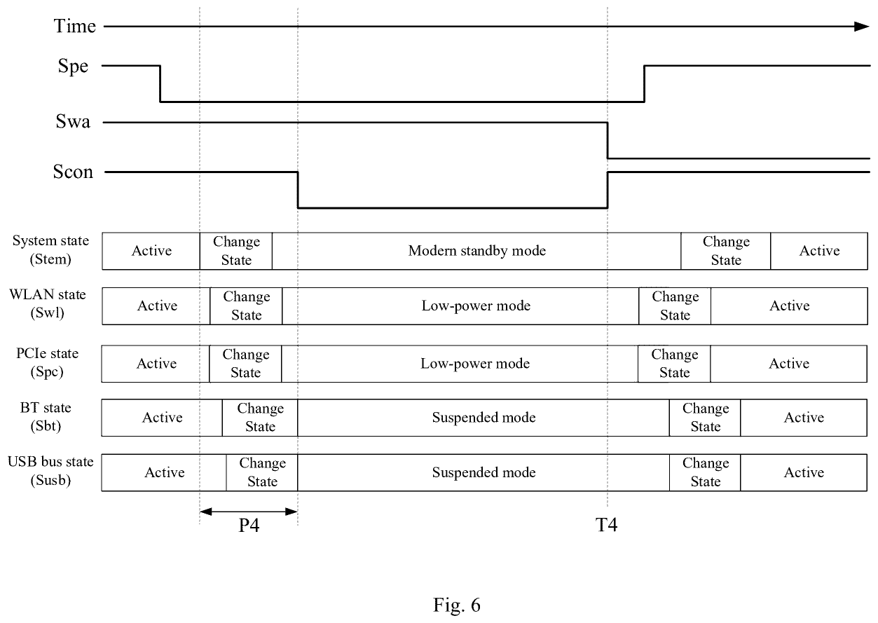

In some embodiments, reference is made to both FIG. 1 and FIG. 6. First of all, the operations of the decision circuit 120 detecting the state during the period P4 and the control circuit 130 removing the resistor 110 are described in the above-mentioned embodiment in FIG. 3, and the operations are therefore omitted herein. Besides, the Remote wake up circuit 140 can transmit the wake up signal Swa (e.g., low electrical level signal) to the control circuit 130 during the time T4, and the control circuit 130 connects the resistor 110 based on the wake up signal Swa (e.g., low electrical level signal).

In some embodiments, the decision circuit 120 can be implemented by media access control (MAC) layer, hardware, or firmware. In some embodiments, the control circuit 130 can be implemented by hardware or firmware. In some embodiments, the Remote wake up circuit 140 can be implemented by hardware or firmware. However, the above-mentioned embodiment is merely utilized to describe one of the implementations, and the present disclosure is not limited thereto. In another embodiment, the decision circuit 120, the control circuit 130, and the Remote wake up circuit 140 of the present disclosure can be implemented by other electronic devices/elements based on actual requirements.

In some embodiments, the application scenario of the universal serial bus device 100 can be a modern standby mode or a wake on wireless lan (WoWLAN) mode. However, the above-mentioned embodiment is merely utilized to describe one of the implementations, and the present disclosure is not limited thereto. In another embodiment, the application scenario of the universal serial bus device 100 of the present disclosure can be other suitable mode based on actual requirements.

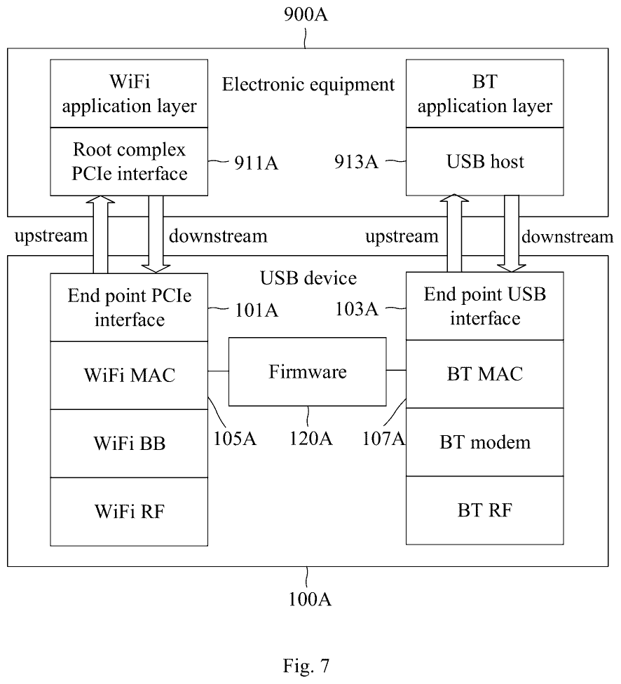

FIG. 7 shows an embodiment of a universal serial bus device 100A and an electronic equipment 900A of the present disclosure. As shown in the figure, the electronic equipment 900A is coupled to the end point PCIe interface 101A of the USB device 100A through the root complex PCIe interface 911A. Besides, the electronic equipment 900A is coupled to the end point USB interface 103A of the USB device 100A through the USB host 913A. In addition, the universal serial bus device 100A can identify the current application scenario through the firmware 120A, and determines whether to remove or connect the pull-up resistor based on the current state of the universal serial bus device 100A. It is noted that the determination manner and the control manner of the universal serial bus device 100A are described in the above-mentioned embodiments, and such manners are omitted herein for the brevity of the specification.

In some embodiments, the universal serial bus device 100A in FIG. 7 does not need the firmware 120A, and the universal serial bus device 100A can make the WiFi MAC 105A or the BT (Bluetooth) MAC 107A do the determination manner and the control manner. In some embodiments, the universal serial bus device 100A can be a network card. In another embodiment, the universal serial bus device 100A can be a combo device of WiFi device and BT device. However, the above-mentioned embodiment is merely utilized to describe one of the implementations, and the present disclosure is not limited thereto. In another embodiment, the universal serial bus device 100A of the present disclosure can be other suitable device/element based on actual requirements.

It is noted that the present disclosure is not limited to the embodiments as shown in FIG. 1 to FIG. 7, it is merely an example for illustrating one of the implements of the present disclosure, and the scope of the present disclosure shall be defined on the bases of the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The universal serial bus device and the control method thereof can adaptively remove a resistor based on the state of the universal serial bus device, thereby avoiding additional power consumption caused by the resistor to meet the power-saving requirements of electronic products.

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A universal serial bus device, comprising:
a resistor, configured to selectively receive a power supply voltage;
a decision circuit, configured to determine whether to remove the resistor based on at least one state of the universal serial bus device, wherein if the decision circuit determines to remove the resistor based on the at least one state of the universal serial bus device, the decision circuit generates a remove signal; and
a control circuit, configured to remove the resistor based on the remove signal.

2. The universal serial bus device of claim 1, wherein if the decision circuit determines to remove the resistor based on an off state of the universal serial bus device, the decision circuit generates the remove signal.

3. The universal serial bus device of claim 1, wherein the control circuit unloads the resistor or cuts off power to the resistor based on the remove signal.

4. The universal serial bus device of claim 1, wherein the decision circuit determines whether to connect the resistor based on the at least one state of the universal serial bus device, wherein if the decision circuit determines to connect the resistor based on the at least one state of the universal serial bus device, the decision circuit generates a connection signal, wherein the control circuit connects the resistor based on the connection signal.

5. The universal serial bus device of claim 4, wherein if the decision circuit determines to connect the resistor based on a change state of the universal serial bus device, the decision circuit generates the connection signal.

6. The universal serial bus device of claim 1, wherein the at least one state of the universal serial bus device comprises one of a system state, a WLAN state, a Bluetooth state, a PCIe state, a universal serial bus state, and a PCIe reset state.

7. The universal serial bus device of claim 1, further comprising:
a remote wake up circuit, configured to transmit a wake up signal to the control circuit, and the control circuit connects the resistor based on the wake up signal.

8. The universal serial bus device of claim 7, wherein the wake up signal comprises one of a WLAN wake up signal and a Bluetooth wake up signal.

9. The universal serial bus device of claim 1, wherein the decision circuit comprises one of a Medium Access Control (MAC) layer and a firmware.

10. The universal serial bus device of claim 1, wherein the universal serial bus device is applied to a modern standby or a wireless network wake up mode.

11. A control method of a universal serial bus device, comprising:
selectively receiving a power supply voltage by a resistor;
determining whether to remove the resistor based on at least one state of the universal serial bus device by a decision circuit;
if the decision circuit determines to remove the resistor based on the at least one state of the universal serial bus device, the decision circuit generates a remove signal; and
removing the resistor based on the remove signal by a control circuit.

12. The control method of claim 11, wherein if the decision circuit determines to remove the resistor based on the at least one state of the universal serial bus device, the decision circuit generates the remove signal comprises:
if the decision circuit determines to remove the resistor based on an off state of the universal serial bus device, the decision circuit generates the remove signal.

13. The control method of claim 11, wherein removing the resistor based on the remove signal by the control circuit comprises:
unloading the resistor or cuts off power to the resistor based on the remove signal by the control circuit.

14. The control method of claim 11, further comprising:
determining whether to connect the resistor based on the at least one state of the universal serial bus device by the decision circuit;
if the decision circuit determines to connect the resistor based on the at least one state of the universal serial bus device, the decision circuit generates a connection signal; and
connecting the resistor based on the connection signal by the control circuit.

15. The control method of claim 14, wherein if the decision circuit determines to connect the resistor based on the at least one state of the universal serial bus device, the decision circuit generates the connection signal comprises:
if the decision circuit determines to connect the resistor based on a change state of the universal serial bus device, the decision circuit generates the connection signal.

16. The control method of claim 11, wherein the at least one state of the universal serial bus device comprises one of a system state, a WLAN state, a Bluetooth state, a PCIe state, a universal serial bus state, and a PCIe reset state.

17. The control method of claim 11, further comprising:
transmitting a wake up signal to the control circuit by a remote wake up circuit, and connecting the resistor based on the wake up signal by the control circuit.

18. The control method of claim 17, wherein the wake up signal comprises one of a WLAN wake up signal and a Bluetooth wake up signal.

19. The control method of claim 11, wherein the decision circuit comprises one of a Medium Access Control (MAC) layer and a firmware.

20. The control method of claim 11, wherein the universal serial bus device is applied to a modern standby or a wireless network wake up mode.
